(19) United States
(12) Patent Application Publication
(10) Pub. No.: US 2026/0134084 A1
(43) Pub. Date: May 14, 2026

(54) ARTIFICIAL INTELLIGENCE CRISIS RESPONSE AND EXECUTION OVERRIDE SYSTEM

(71) Applicant: George William Bickerstaff, III, Greenwich, CT (US)

(72) Inventor: George William Bickerstaff, III, Greenwich, CT (US)

(21) Appl. No.: 19/444,370

(22) Filed: Jan. 9, 2026

(51) Int. Cl. G06F 21/52

(52) U.S. Cl. CPC G06F 21/52

(57) ABSTRACT

An artificial intelligence crisis response and execution override system detects crisis conditions, classifies severity, intercepts autonomous execution prior to completion, applies override and continuity controls, and generates auditable artifacts enabling deterministic replay and post-crisis recovery.

### TECHNICAL FIELD

The present invention relates to artificial intelligence control systems and, more particularly, to systems and methods for detecting crisis conditions, classifying severity, and enforcing execution-time overrides and continuity controls for artificial intelligence systems operating in high-risk or mission-critical environments.

### BACKGROUND

Artificial intelligence systems are increasingly deployed to operate autonomously in environments where incorrect or uncontrolled actions may cause significant harm. Such environments include critical infrastructure, healthcare delivery, financial markets, transportation systems, defense platforms, and public safety systems. In these contexts, autonomous decision-making systems must remain responsive not only to normal operating conditions but also to crisis scenarios.

Existing artificial intelligence systems typically rely on static safety rules or post-incident human intervention. These approaches are insufficient during rapidly evolving crises, where autonomous actions may need to be intercepted, constrained, or overridden in real time. Without coordinated crisis response mechanisms, autonomous systems may amplify harm during abnormal conditions.

Accordingly, there exists a need for a technical system that continuously monitors for crisis conditions, classifies severity, dynamically overrides autonomous execution when necessary, coordinates system-wide response, and generates auditable records enabling replay and verification of crisis actions.

### SUMMARY OF THE INVENTION

The invention provides an artificial intelligence crisis response and execution override system configured to detect crisis conditions, classify severity, and enforce execution-time overrides across one or more artificial intelligence systems. The system intercepts autonomous actions prior to completion, applies override policies and continuity controls based on severity, and coordinates response across dependent subsystems.

By embedding crisis response and override enforcement directly into the execution pathway, the system prevents irreversible actions during abnormal conditions, preserves essential functionality, and enables deterministic audit, replay, and post-crisis recovery.

### DEFINITIONS

### Crisis Audit Artifact

A cryptographically verifiable data structure recording detected crisis signals, severity classification, override actions, state transitions, and execution metadata.

### Crisis Condition

A detected abnormal state indicating elevated risk or potential harm requiring intervention.

### Crisis State Indicator

A machine-readable flag representing current crisis status and severity.

### Dependency Graph

A representation of functional dependencies between system components.

### Execution Interception Layer

A control layer that intercepts autonomous execution prior to completion.

### Override Policy

A predefined rule set governing permitted and prohibited actions during a crisis.

### Severity Level

A classification representing the magnitude or impact of a crisis condition.

### Telemetry Signal

A system-generated metric indicating operational state or performance.

### Violation Threshold

A predefined boundary indicating unacceptable risk or abnormal behavior.

### Continuity Mode

A restricted operational state preserving essential functionality during crisis response.

### BRIEF DESCRIPTION OF THE DRAWINGS

FIG. 1 illustrates crisis signal ingestion and monitoring.

FIG. 2 illustrates crisis detection and severity classification.

FIG. 3 illustrates execution override and continuity control.

FIG. 4 illustrates coordinated system response.

FIG. 5 illustrates audit, replay, and post-crisis recovery.

### DETAILED DESCRIPTION

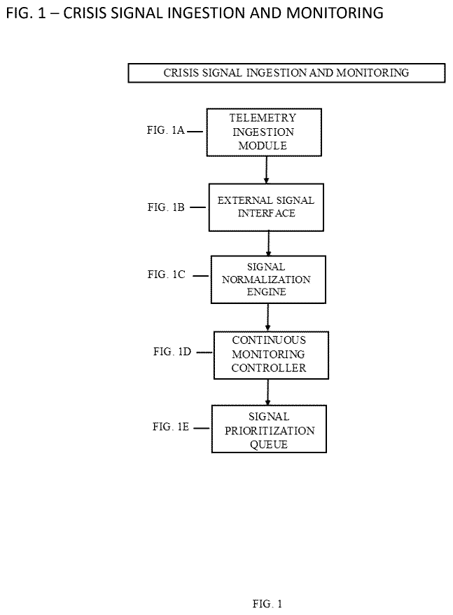

### FIG. 1—Crisis Signal Ingestion and Monitoring

FIG. 1 illustrates ingestion and monitoring of signals indicative of a crisis condition. Signals are collected from internal and external sources. The signals are normalized and continuously evaluated.

### FIG. 1A—Telemetry Ingestion Module

FIG. 1A depicts a module configured to ingest system telemetry data. Telemetry includes performance, error, and state indicators. Ingested data is forwarded for evaluation.

### FIG. 1B—External Signal Interface

FIG. 1B illustrates an interface receiving external crisis signals. External signals may include alerts or environmental indicators. Received signals are normalized for processing.

### FIG. 1C—Signal Normalization Engine

FIG. 1C shows an engine that converts heterogeneous signals into a canonical format. Normalization enables consistent evaluation. Signal ambiguity is reduced.

### FIG. 1D—Continuous Monitoring Controller

FIG. 1D depicts a controller that continuously evaluates incoming signals. Evaluation occurs in real time. Results are forwarded for crisis classification.

### FIG. 1E—Signal Prioritization Queue

FIG. 1E illustrates prioritization of signals based on urgency. Higher-priority signals are evaluated first. Ordering supports timely response.

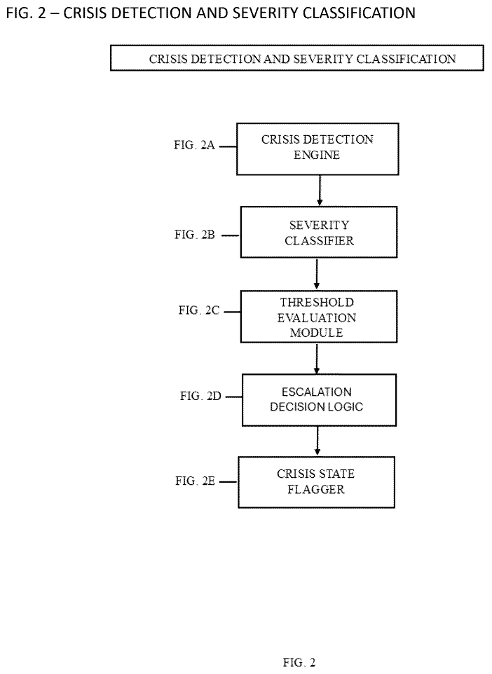

### FIG. 2—Crisis Detection and Severity Classification

FIG. 2 illustrates detection of crisis conditions and classification of severity. Signals are evaluated against predefined criteria. Severity levels guide downstream response.

### FIG. 2A—Crisis Detection Engine

FIG. 2A depicts detection of abnormal conditions. Detection logic evaluates signal patterns. Detected events are forwarded for classification.

### FIG. 2B—Severity Classifier

FIG. 2B illustrates classification of detected events into severity levels. Severity reflects potential system impact. Classified severity informs override behavior.

### FIG. 2C—Threshold Evaluation Module

FIG. 2C shows comparison of signal metrics against thresholds. Threshold breaches indicate escalation. Results trigger response workflows.

### FIG. 2D—Escalation Decision Logic

FIG. 2D depicts logic determining whether escalation is required. Decisions are rule-based. Escalation outputs are recorded.

### FIG. 2E—Crisis State Flagger

FIG. 2E illustrates assignment of a crisis state indicator. The indicator represents current system status. State flags persist during response.

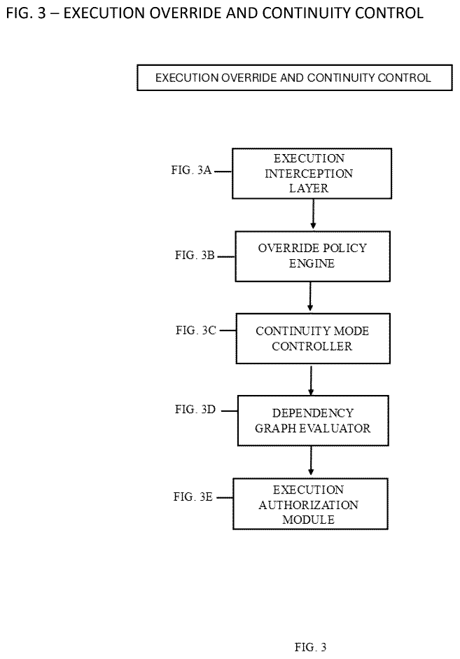

FIG. 3—Execution Override and Continuity Control

FIG. 3 illustrates execution interception and override during crisis response. Autonomous actions are intercepted prior to completion. Continuity controls are applied.

### FIG. 3A—Execution Interception Layer

FIG. 3A depicts interception of autonomous execution paths. Interception prevents irreversible actions. Intercepted executions are rerouted.

### FIG. 3B—Override Policy Engine

FIG. 3B illustrates application of override policies. Policies determine permitted actions during crisis. Policy outcomes guide execution control.

### FIG. 3C—Continuity Mode Controller

FIG. 3C shows activation of continuity operation modes. Essential functions are preserved. Non-essential functions are constrained.

### FIG. 3D—Dependency Graph Evaluator

FIG. 3D depicts evaluation of system dependencies. Dependencies determine override order. Evaluation prevents cascading failures.

### FIG. 3E—Execution Authorization Module

FIG. 3E illustrates authorization of permitted actions. Only compliant actions proceed. Authorization decisions are logged.

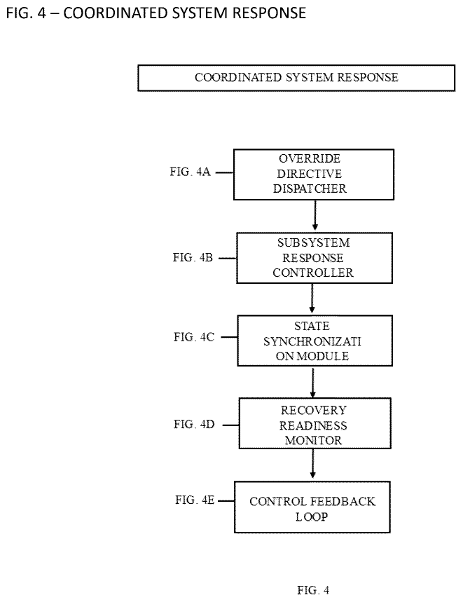

### FIG. 4—Coordinated System Response

FIG. 4 illustrates coordinated response across distributed system components. Override directives are propagated. Consistency is maintained.

### FIG. 4A—Override Directive Dispatcher

FIG. 4A depicts distribution of override commands. Commands are transmitted to dependent systems. Delivery is verified.

### FIG. 4B—Subsystem Response Controller

FIG. 4B illustrates subsystem-level response handling. Subsystems adapt behavior based on directives. Responses are synchronized.

### FIG. 4C—State Synchronization Module

FIG. 4C shows synchronization of system state. State consistency is enforced. Divergence is corrected.

### FIG. 4D—Recovery Readiness Monitor

FIG. 4D depicts monitoring for recovery conditions. Signals indicate stabilization. Readiness is assessed continuously.

### FIG. 4E—Control Feedback Loop

FIG. 4E illustrates feedback between response components. Feedback refines ongoing response. Adjustments are recorded.

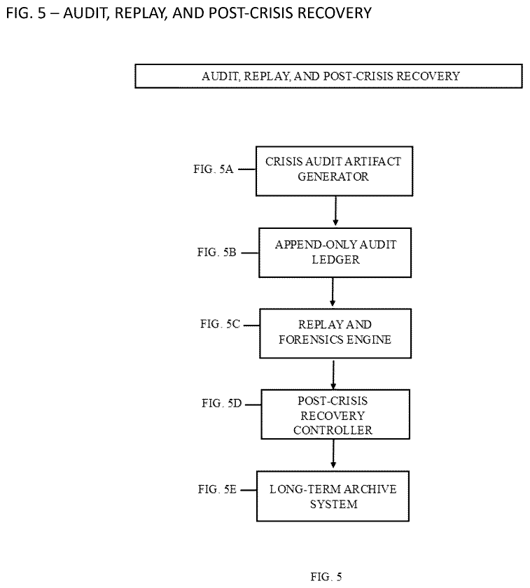

### FIG. 5—Audit, Replay, and Post-Crisis Recovery

FIG. 5 illustrates audit capture and recovery following a crisis. All actions are recorded deterministically. Artifacts support verification.

### FIG. 5A—Crisis Audit Artifact Generator

FIG. 5A depicts generation of crisis audit artifacts. Artifacts capture overrides and state transitions. Records are cryptographically verifiable.

### FIG. 5B—Append-Only Audit Ledger

FIG. 5B illustrates storage of artifacts in an append-only ledger. Records cannot be altered. Integrity is preserved.

### FIG. 5C—Replay and Forensics Engine

FIG. 5C shows deterministic replay of crisis events. Replay reconstructs execution order. Forensic analysis is supported.

### FIG. 5D—Post-Crisis Recovery Controller

FIG. 5D depicts controlled transition back to normal operation. Recovery follows predefined rules. Stability is ensured.

### FIG. 5E—Long-Term Archive System

FIG. 5E illustrates long-term storage of crisis records. Archives support retention requirements. Data remains accessible.

### ILLUSTRATIVE OPERATIONAL EXAMPLE (NON-LIMITING)

In one illustrative example, an artificial intelligence system operates a distributed infrastructure service under normal autonomous control. Telemetry ingestion and external signal monitoring detect abnormal conditions exceeding predefined thresholds. A crisis condition is detected and classified by severity.

The execution interception layer halts autonomous actions prior to completion. Override policies and dependency evaluation determine which functions enter continuity mode. Coordinated override directives are propagated across dependent subsystems.

All override actions and state transitions are captured in a crisis audit artifact. Upon stabilization, the post-crisis recovery controller transitions the system back to normal operation. Recorded artifacts enable replay and verification of all crisis actions.

1. An artificial intelligence crisis response system comprising a crisis detection engine, a severity classifier, an execution interception layer, and an override policy engine configured to enforce execution-time overrides during a crisis condition.

2. A method for artificial intelligence crisis response comprising detecting a crisis condition, classifying severity, intercepting autonomous execution, and applying override policies prior to execution completion.

3. A non-transitory computer-readable medium storing instructions that cause a system to detect crisis conditions and enforce execution-time overrides.

4. The system of claim 1, wherein crisis signals include telemetry signals.

5. The system of claim 1, wherein override policies include continuity mode constraints.

6. The method of claim 2, further comprising generating a crisis audit artifact.

7. The method of claim 2, wherein execution is coordinated across dependent subsystems.

8. The system of claim 1, wherein crisis audit artifacts are stored in an append-only ledger.

9. The medium of claim 3, wherein replay reconstructs crisis execution state.

10. The system of claim 1, wherein recovery transitions are governed by predefined rules.
